(19) United States
(12) Patent Application Publication
(10) Pub. No.: US 2009/0032456 A1
(43) Pub. Date: Feb. 5, 2009

(54) DEVICE FOR FILTERING A FLUID ESPECIALLY A LIQUEFIED PLASTIC

(75) Inventors: Robert Middler, Havixbeck (DE); Oliver Brandt, Bremervorde (DE); Dirk Bussmann, Nottuln (DE); Michael Andress, Altenberge (DE); Stefan Wostmann, Sassenberg (DE)

Correspondence Address: MERCHANT & GOULD PC, P.O. BOX 2903, MINNEAPOLIS, MN, 55402-0903, US

(73) Assignee: Kreyenborg Verwaltungen und Beteiligungen GmbH & Co. KG, Munster (DE)

(21) Appl. No.: 12/174,311

(22) Filed: Jul. 16, 2008

(30) Foreign Application Priority Data
Jul. 30, 2007 (DE) 10 2007 036 013.6
Dec. 11, 2007 (DE) 10 2007 059 579.6

(51) Int. Cl. B01D 39/10

(52) U.S. Cl. 210/499

(57) ABSTRACT

A device for filtering a fluid, in particular a liquefied plastic, has a housing with at least one supply channel and having a discharge channel. In the flow path of the fluid at least one screen is arranged in a corresponding screen space in at least one screen carrier, which is supported so as to be displaceable crosswise to the direction of flow. The screen can be brought into connection with the supply channel and with the discharge channel, the screen being formed as an elongate oval or a polygon. The channel splits into two partial supply channels, which open out into the screen space on the dirty side of the screen. The front supply channel, viewed in the screen change direction, opens out into a channel worked into the screen carrier, which channel feeds to the screen space the plastic to be filtered.

### BACKGROUND OF THE INVENTION

The invention relates to a device for filtering a fluid, in particular a liquefied plastic, according to the preamble of the main claim.

In the following, the terms “screen” and “filter element” are used in a general manner, so that signified by these terms are the most diverse screens, filters or other retaining apparatus for contaminants.

Described in US 2005/001 6914 A1 is a device for filtering a fluid, in particular for plastic-processing systems, in which device the supply channel for the plastic to be filtered is divided into at least two partial supply channels, which in the production position lead to the actual screen chambers. After the flowing through the screen, two screen-carrier partial channels per screen chamber lead to two housing partial channels to the discharge channel provided above the supply channel; in this, the merging of these at least four housing partial channels takes place in the wall of the housing.

Created with this known arrangement is a system in which the largest possible screen surface areas are achievable with the smallest possible screen-carrier diameters and screen-changer housings. The construction of the channels is possible in a technically simple manner and the intention is to keep the screen-carrier length as short as possible.

The forming of the screen as an oval has become known from DE 295 17 140 U1 and the forming of the screen as a polygon has become known from DE-GM 87 01 110. Pursued here, too, is the goal of installing as large as possible a screen surface in as small as possible a screen carrier.

From the representation of the arrangement according to DE 295 17 140 U1, it can be recognized that during a screen change and thus during a pushing out of the screen carrier, the actual screen chamber is connected to the supply channel over a relatively long displacement, before this connection is interrupted.

### SUMMARY OF THE INVENTION

The present invention is based on the task of equipping a screen carrier with an elongate oval or polygonal filter element, wherein, during the guiding of the screen carrier for the purpose of backflushing or screen changing, the supplying to the screen chamber of the fluid to be filtered is interrupted relatively immediately upon movement of the screen carrier.

Thus, described is an arrangement in which a screen or filter element is arranged in the screen carrier, while an arrangement in which, in a manner known in itself, provided in the screen carrier are two opposing screens in one screen chamber.

In both cases, two partial supply channels lead from the supply channel to the screen chamber worked into the screen carrier, so that this chamber, viewed in the screen-change direction, is fed in the front and rear regions with plastic to be filtered. The front partial supply channel, viewed in the screen-change direction, here opens into a channel worked into the screen carrier, which channel supplies the plastic to be filtered to the screen chamber.

If two opposing screens or filter elements are provided in one screen chamber, the rear partial supply channel, viewed in the screen-change direction, splits in an inverted V-shaped manner and thus opens out on both dirty sides of the screens, while the front partial supply channel opens out into a guide channel worked into the screen carrier, which guide channel leads to the two filter elements on the dirty side of the screens.

It is apparent that through displacement of the screen carrier the mouth of the front partial supply channel is closed off after a displacement that corresponds to the diameter of the partial supply channel, so that the supplying of the plastic to be filtered is interrupted after a very short displacement.

It goes without saying that both of the above-described arrangements can also be developed in a backflush version, wherein appropriate channel guides must be provided.

### BRIEF DESCRIPTION OF THE DRAWINGS

In the following, an embodiment example of the invention is explained with reference to the drawings. In the drawings:

FIG. 1: shows diagrammatically the arrangement according to the invention, wherein a screen carrier is pulled forward out of the housing in order to exchange the filter element.

FIG. 2: shows a section through the housing and screen carrier in the region of the guide channel.

FIG. 3: shows a section through the housing and screen carrier in the region of the mouth of the rearward partial supply channel.

FIG. 4: shows a modified embodiment form of the arrangement according to FIG. 2 with two connecting channels.

FIG. 5: shows schematically a side view of the arrangement according to FIG. 1.

FIG. 6: shows schematically a plan view of the arrangement according to FIG. 1.

FIG. 7: shows a screen carrier when the latter has been withdrawn from the housing.

### DETAILED DESCRIPTION OF THE PREFERRED EMBODIMENTS

Labeled as 1 in the drawings in a housing that displays a supply channel 2 and a discharge channel 3 for liquefied plastic, wherein two screen carriers 4, 4a are provided in the represented embodiment example on the path from the supply channel 2 to the discharge channel 3. As is shown in FIG. 3, so-called screen spaces 7 or cavities are worked into the screen carriers, in which spaces are arranged filter elements or screens 5 and 6, which in the case of the embodiment example represented in FIG. 3 are arranged so as to oppose each other, so that the plastic to be filtered is fed from the outside and discharged in the interior.

It goes without saying that the invention also relates to a screen carrier in which only one screen is arranged.

Starting from the supply channel 2, the latter splits into two partial supply channels 2a and 2b, wherein the partial supply channel 2a leads in the screen-change direction R, while the partial supply channel 2b, viewed in the screen-change direction R, leads toward the rearward dirty surface of the screen.

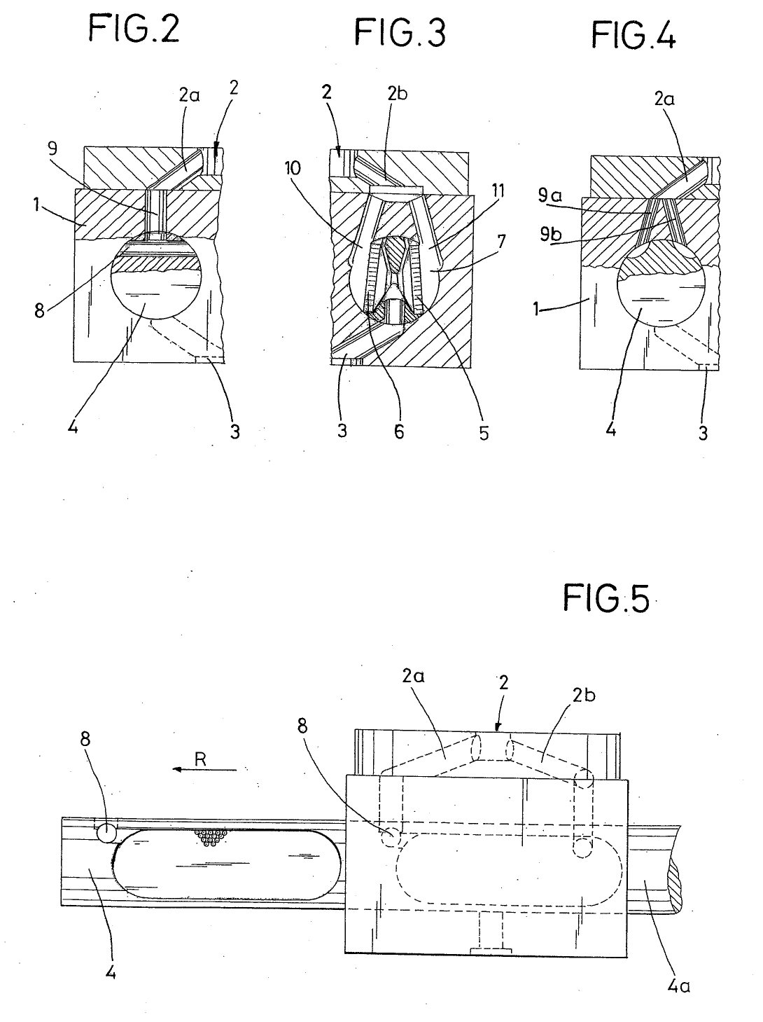

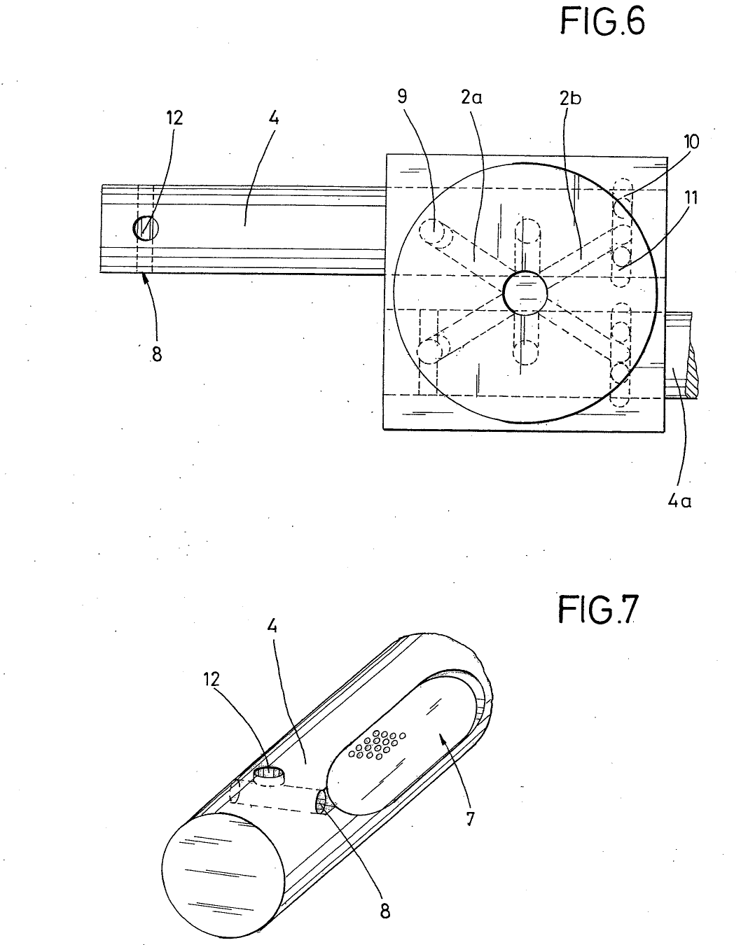

FIG. 2 shows that, when two opposing filter elements 5 and 6 are arranged in the screen space 7, a connecting channel 9 is worked into the housing 1, which connecting channel is connected at one end to the partial supply channel 2a and at the other end opens out at the screen carrier 4 centrally with respect to the circumference, i.e. at a 12 o'clock position. Here, this end of the connecting channel 9 is connected to a guide channel 8, which leads to the two dirty sides of the screens 5 and 6. The connecting channel 9 is aligned with a corresponding bore 12 in the screen carrier 4 (FIG. 6), which furnishes the connection with the guide channel 8.

FIG. 4 shows an embodiment form in which the partial supply channel 2a leads to two connecting channels 9a and 9b worked into the housing 1, which connecting channels open out into guides in the filter carrier 4, which guides lead to the two dirty sides of the screens 5 and 6.

It is evident from this that upon a movement of the screen carrier 4 by a length that corresponds to the diameter of the connecting channel 9 or, as the case may be, of the two connecting channels 9a and 9b, a separation of the screen space 7 from the partial supply channel 2a occurs.

Viewed in the screen-change direction R, the rearward partial supply channel 2b splits again inside the housing into two connecting channels 10 and 11, which in turn open out into the screen space 7 on the dirty side of the screens 5 and 6 (see FIG. 3).

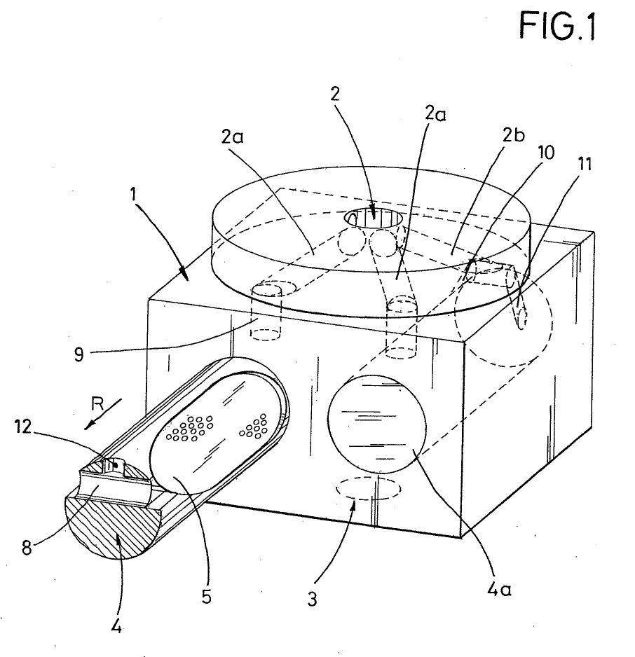

At this point it should be pointed out explicitly that the guide channel 8 can be implemented, as represented in FIGS. 1 and 2, as a bore inside the screen carrier 4, but similarly the possibility exists of having the connecting channel 9 open out into a groove at the top side of the screen carrier 4, which groove is provided instead of the guide channel 8.

Not represented in the drawings is the possibility of also forming the described invention in a backflush version, wherein appropriate channel guides must be provided.

1. Device for filtering a liquefied plastic, comprising a housing with at least one supply channel and a discharge channel, wherein in the flow path of the fluid at least one screen is arranged in a corresponding screen space in at least one screen carrier, which is supported so as to be displaceable crosswise to the direction of flow, wherein the screen can be brought into connection with the supply channel and with the discharge channel, the screen being formed as an elongate oval or a polygon, wherein the supply channel splits into two partial supply channels, which open out into the screen space on a dirty side of the screen, wherein the front partial supply channel, viewed in the screen change direction, opens out into a guide channel provided in the screen carrier, wherein the channel feeds to the screen space the plastic to be filtered.

2. Device according to claim 1, wherein two opposing filter screens are arranged in one screen space wherein the rear partial supply channel, viewed in the screen change direction, splits in an inverted V-shaped manner and leads to the two screens on the dirty side of the screen, and the front partial supply channel, viewed in the screen change direction, opens out into the guide channel provided in the screen carrier, wherein the guide channel leads to the two screens on the dirty side of the screen.

3. Device according to claim 2, wherein the guide channel is provided as a bore in the screen bolt.

4. Device according to claim 2, wherein the guide channel is worked into the screen bolt as a groove.

5. Device according to claim 2, wherein the partial supply channel opens out into two connecting channels provided in the housing, which connecting channels lead directly or indirectly to the two dirty sides of the screens.

6. Device according to claim 2, wherein the partial supply channel opens out at the screen bolt centrally with respect to the circumference and is connected to the guide channel.

7. Device according to claim 5, wherein the partial supply channel opens out at the screen bolt centrally with respect to the circumference and is connected to the connecting channels.
